(19) United States
(12) Patent Application Publication
(10) Pub. No.: US 2026/0349677 A1
(43) Pub. Date: Nov. 5, 2026

(54) AUTOMATED DESIGN AND GENERATION OF MICROSERVICE SYSTEMS

(71) Applicant: Microsoft Technology Licensing, LLC, Redmond, WA (US)

(72) Inventors: Pedro Henrique BRAGIONI LAS CASAS, Belo Horizonte (BR); Rodrigo FONSECA, Bothel, WA (US); Ricardo BIANCHINI, Bellevue, WA (US); Alok Gautam KUMBHARE, Sammamish, WA (US); VAASTAV, Saarbruecken (DE)

(21) Appl. No.: 19/195,537

(22) Filed: Apr. 30, 2025

(51) Int. Cl. G06F 8/35; G06F 8/41

(52) U.S. Cl. CPC G06F 8/35; G06F 8/41

(57) ABSTRACT

Methods, apparatuses, and products for automated design and generation of microservice systems, including: generating a structural architecture of a microservice system by requesting a generative artificial intelligence (AI) model to generate the structural architecture based on a natural language description of one or more requirements of the microservice system; generating, for one or more components of the structural architecture and based on a user acceptance of the structural architecture, a corresponding interface of one or more interfaces by requesting the generative AI model to generate the one or more interfaces, wherein the one or more interfaces each comprise one or more function signatures; generating code implementing the one or more interfaces by requesting the generative AI model to generate the code; and compiling the code implementing the one or more interfaces to generate a build of the microservice system.

### BACKGROUND

Software applications can be implemented using various architectures, including microservice systems. In microservice systems, the application is built using multiple independently deployable services encapsulating some specific task or function to be performed in the application. These services may intercommunicate with each other using application program interfaces (APIs) or messages to implement the overall functionality of the application.

Microservice systems present many advantages. For example, each service can be developed independently, allowing for the development of specific services to be distributed and parallelized across multiple teams. As another example, services can be developed modularly, potentially allowing for some services to be reused across multiple applications. Once deployed, each service can be run as an independent process. This allows for each service to be monitored, scaled, and troubleshooted independently.

Despite these advantages, the complexity of the architecture presents difficulty when developing the application. For example, more complex applications may require a comparatively large number of services to implement, increasing the overall complexity and design of the application architecture. This may also necessitate complex dependencies between services, making testing more difficult and potentially leading to bugs or other performance defects.

### SUMMARY

According to embodiments of the present disclosure, various methods, apparatus, and products for automated design and generation of microservice systems are described herein. In some aspects, automated design and generation of microservice systems includes: generating a structural architecture of a microservice system by requesting a generative artificial intelligence (AI) model to generate the structural architecture based on a natural language description of one or more requirements of the microservice system; generating, for one or more components of the structural architecture and based on a user acceptance of the structural architecture, a corresponding interface of one or more interfaces by requesting the generative AI model to generate the one or more interfaces, wherein the one or more interfaces each comprise one or more function signatures; generating code implementing the one or more interfaces by requesting the generative AI model to generate the code; and compiling the code implementing the one or more interfaces to generate a build of the microservice system. In some aspects, an apparatus may include a memory and one or more processing devices, operatively coupled to the memory, the one or more processing devices configured to perform similar steps. In some aspects, a computer program product comprising a computer readable storage medium may store computer program instructions that, when executed, perform similar steps.

### BRIEF DESCRIPTION OF DRAWINGS

FIG. 1 sets forth a diagram of an example computing environment for automated design and generation of microservice systems in accordance with some embodiments.

FIG. 2 sets forth a flow chart illustrating an example method of automated design and generation of microservice systems in accordance with some embodiments.

FIG. 3 sets forth a flow chart illustrating an additional example method of automated design and generation of microservice systems in accordance with some embodiments.

FIG. 4 sets forth a flow chart illustrating an additional example method of automated design and generation of microservice systems in accordance with some embodiments.

FIG. 5 sets forth a flow chart illustrating an additional example method of automated design and generation of microservice systems in accordance with some embodiments.

FIG. 6 sets forth a flow chart illustrating an additional example method of automated design and generation of microservice systems in accordance with some embodiments.

FIG. 7 sets forth a flow chart illustrating an additional example method of automated design and generation of microservice systems in accordance with some embodiments.

FIG. 8 sets forth a flow chart illustrating an additional example method of automated design and generation of microservice systems in accordance with some embodiments.

FIG. 9 illustrates an exemplary computing device that may be specifically configured to perform one or more of the processes described in the present disclosure.

FIG. 10 sets forth a block diagram of a cloud service provider service architecture in accordance with some embodiments of the present disclosure.

### DESCRIPTION OF EMBODIMENTS

A microservice system is an architecture for a software application whereby the application is built as a collection of small, independently deployable services each handling a specific function, intercommunicating using application programming interfaces (APIs) or messages. This allows for individual services to be developed independently, parallelizing development by allowing smaller teams to develop their respective services separately. Moreover, as each service can be run as an independent process, each service can be monitored and scaled independently.

Despite these advantages and the applicability of the architecture across a variety of applications, the complexity of the architecture presents difficulty when developing the application. For example, more complex applications may require a comparatively large number of services to implement, increasing the overall complexity and design of the application architecture. This may also necessitate complex dependencies between services, making testing more difficult and potentially leading to bugs or other performance defects.

To address these concerns, the approaches set forth herein leverage the abilities of generative artificial intelligence (AI) models, such as large language models (LLMs), to interpret and create code and natural language content. A natural language description of system requirements is used by the generative AI model to create a high-level architecture for a microservice system. The model then uses the high-level architecture to create interfaces for the components of the microservice system and ultimately the code to implement these interfaces. The resulting code is then compiled into a build of the microservice system. A user can review and approve various stages of this process to ensure that each stage is completed satisfactorily before entering the next stage.

Microservice architectures provide many benefits for developing and deploying applications at the expense of increased development and deployment complexity. This may increase the amount of time required by developers to design, create, and test their applications. The approaches set forth herein allow for automated development of microservice systems by leveraging generative AI capabilities. This may expedite design and development of an application using a microservice architecture, improving developer productivity and reducing development costs.

The described techniques enable a structured, step-by-step process for generating microservice-based applications using AI. By combining automated generation with user-guided validation at each stage (e.g., from initial requirements to final implementation), the embodiments described herein offer a practical way to accelerate development while maintaining control and oversight. This approach is adaptable to different project needs, including building new systems, extending existing ones, or modernizing legacy architectures. By automating the design of service architectures, interfaces, and corresponding implementations, and by generating independent tests alongside each component, the techniques help reduce integration errors and improve consistency across the resulting microservice system. These improvements can enhance the correctness, maintainability, and deployability of the generated application, particularly as system complexity increases.

Offering a solution that automates the generation of microservice-based applications using AI can significantly reduce the time and cost associated with software development. By accelerating architecture design, code implementation, and testing, businesses can bring new products to market faster and respond more quickly to changing requirements. The approach also helps mitigate risks related to code quality and developer error, reducing the cost of downstream maintenance and rework. Additionally, it allows teams to reallocate engineering resources to higher-value tasks, increasing overall productivity and competitiveness.

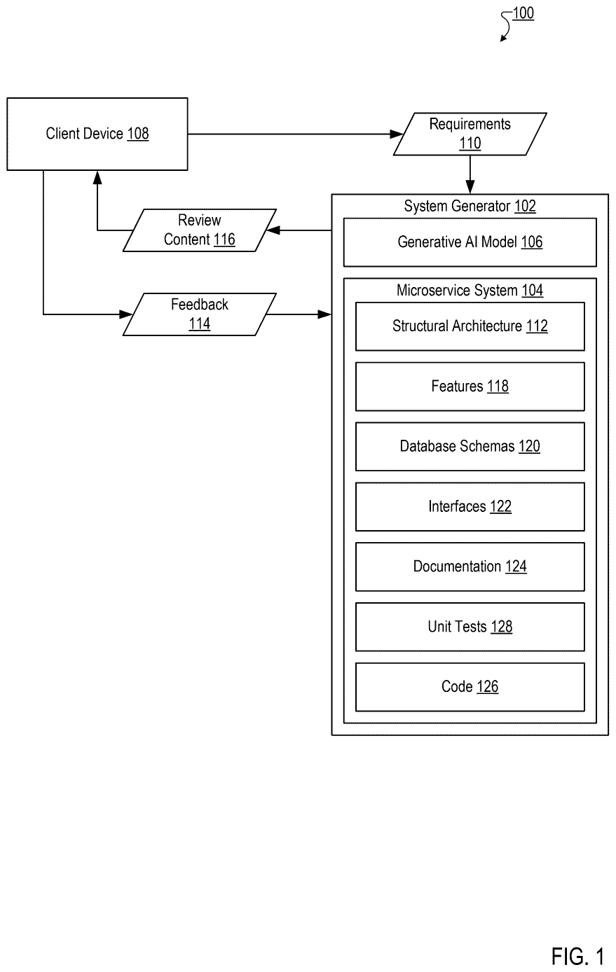

FIG. 1 sets forth a diagram of an example computing environment 100 for automated design and generation of microservice systems in accordance with some embodiments of the present disclosure. The computing environment 100 includes a system generator 102. The system generator 102 is a collection of hardware and/or software resources for automatically generating a microservice system 104 using a generative artificial intelligence (AI) model 106. As would be understood by one skilled in the art, a microservice system 104 is a software system, such as an application, implementing a microservice architecture whereby the microservice system 104 is implemented using multiple independently operating and intercommunicating services.

The generative AI model 106 is a machine learning model trained to perform generative AI functions. As referred to herein, generative AI uses models such as neural networks, including large language models (LLMs), multimodal large language models (MLMMs), and the like to generate content, such as text, code, graphics, animations, video, audiovisual representations, audio, speech, etc., in response to prompts. The generative AI models are trained using a corpus of training data content to learn the patterns and structure of that content. The generative AI model may then generate new content having the characteristics learned from the training data. Prompts may include text, code, audio, graphic, video, and representations in any other media. Such prompts may be provided to the generative AI model as a natural language input. For example, the approaches set forth herein may interact with a generative AI model using predefined prompts, dynamically generated prompts, prompts that include some portion of dynamically generated content (e.g., through the use of templates and dynamically populated variables), and the like.

Accordingly, in some embodiments, the generative AI model 106 may include any type of trained machine learning model capable of generative AI, including LLMs or other language models as can be appreciated. Additionally, the generative AI model 106 may be implemented using various architectures for trained machine learning models. In some embodiments, the generative AI model 106 may be implemented using a transformer architecture. A generative AI model 106 using a transformer architecture includes a tokenizer that converts input data into tokens and an embedding layer that converts those tokens and their relative positions into vector representations (e.g., vectors of numerical values that may correspond to points in multidimensional space). Transformer layers of the generative AI model 106 perform repeated transformations on these vector embeddings using attention and feed-forward layers. The final vector representations are then converted into a probability distribution over the tokens that is then converted into the final output.

In some embodiments, the generative AI model 106 is implemented locally relative to the system generator 102, such as in a same computing system, computing environment 100, and the like. In some embodiments, the generative AI model 106 may be implemented remotely disposed from the system generator 102. For example, in some embodiments, the generative AI model 106 may be deployed and maintained by a third-party provider and made accessible to the system generator 102 using an exposed application program interface (API) or other interface as can be appreciated.

In some embodiments, the generative AI model 106 includes a general-purpose or “off-the-shelf” model that has not been specifically trained or fine-tuned to perform the tasks or functions described herein. In some embodiments, the generative AI model 106 includes a specially trained model that has been trained or fine-tuned using some set of training data specifically applicable to the tasks or functions described herein.

To generate the microservice system 104, the system generator 102 uses the generative AI model 106 to generate various components of, or data associated with, the microservice system 104 in a hierarchical fashion. This includes generating some content or data for the microservice system 104 at a higher level and using that content or data to generate content for a next, lower level. To do so, the system generator 102 receives, from a client device 108, a natural language description of one or more requirements 110 for the microservice system 104. The requirements 110 describe various aspects that should be present in or supported by the microservice system 104 as generated by the system generator 102. In some embodiments, the requirements 110 include a general description of the microservice system 104. In some embodiments, these requirements 110 include one or more functional requirements 110. Functional requirements 110 describe specific tasks, functions, or actions that should be performed by the microservice system 104. In some embodiments, the functional requirements 110 are described from the perspective of a particular user or type of user of the microservice system 104.

Accordingly, in some embodiments, the functional requirements 110 may be described or expressed as user stories. For example, for a microservice system 104 implementing a polling application, functional requirements 110 may be described using the user stories “As a poll creator, I should be able to create a new poll and provide options that other people can vote for. As a poll creator, I should be able to add tags to my poll so that the voters can find new polls. As a voter, I should be able to search for polls based on themes, vote in a specific poll, and view the results of the poll. As a user, I should be able to see my profile which includes all the polls I have created and all the polls I have voted in. As a user, I should also be able to leave comments about polls and view comments from others.” In this example, the functional requirements 110 describe various functions that poll creators, voters, and general users should be able to perform using the microservice system 104.

In some embodiments, the requirements 110 include behavioral requirements 110. Behavioral requirements 110 describe general behavior of the microservice system 104 as opposed to specific functions. For example, behavioral requirements 110 may describe aspects of the microservice system 104 such as scalability, security, performance, and the like. In some embodiments, these behavioral requirements 110 may be expressed as free-form natural language expressions. For example, behavioral requirements 110 for the microservice system 104 may be described as follows: “The app should allow users to easily debug issues if things go wrong and it should have timely responses under high load.”

The system generator 102 requests that the generative AI model 106 generate a structural architecture 112 for the microservice system 104 based on the requirements 110. In some embodiments, the system generator 102 provides the requirements 110 to the generative AI model 106 as part of a prompt or other request to generate the structural architecture 112. The structural architecture 112 describes or encodes various high-level components of the microservice system 104. For example, in some embodiments, the structural architecture 112 includes one or more services to be included in the microservice system 104. In some embodiments, the structural architecture 112 includes a user interface or other front-end component for interacting with one or more of these services. In some embodiments, the structural architecture 112 includes one or more databases accessible to one or more of these services. In other words, the structural architecture 112 describes one or more logical entities of the microservice system 104. Readers will appreciate that these components are merely illustrative and that other components are also contemplated within the scope of the present disclosure.

In some embodiments, the structural architecture 112 describes the various components of the microservice system 104 and one or more dependencies or other relationships between those components. For example, where a service accesses another service, the structural architecture 112 may indicate this relationship as a dependency. Accordingly, in some embodiments, the structural architecture 112 may be encoded as a graph representation with each entity of the microservice system 104 represented by a node and each dependency or relationship represented by an edge between nodes. In some embodiments, the structural architecture 112 may be encoded as an Entity Relationship (ER) diagram or other diagram as can be appreciated.

After receiving the structural architecture 112 from the generative AI model 106 the system generator 102 provides the structural architecture 112 to the client device 108 for user review. In some embodiments, the system generator 102 will provide various content generated by the generative AI model 106 to the client device 108. This may be done, for example, to solicit feedback 114 from a user (e.g., an acceptance, rejection, and/or modification of the content) or for illustrative or explanatory purposes so as to inform a user. Such content is shown as review content 116. Here, the system generator 102 provides the structural architecture 112 to the client device 108 as review content 116, soliciting feedback 114 from a user of the client device 108.

In some embodiments, providing the structural architecture 112 to the client device 108 causes a visual representation of the structural architecture 112 to be rendered or presented by the client device 108, such as a graph visualization depicting the various entities and dependencies encoded by the structural architecture 112. The client device 108 then provides feedback 114 for the structural architecture 112 to the system generator 102. In some embodiments, the feedback 114 includes an acceptance of the structural architecture 112. In some embodiments, the feedback 114 includes a modification to the structural architecture 112. This may include, for example, addition or removal of one or more components, addition or removal of one or more dependencies or relationships, and the like. In some embodiments, where the feedback 114 includes a modification to the structural architecture 112, this feedback 114 may be treated as an implicit acceptance of the structural architecture 112 as modified.

In response to an acceptance of the structural architecture 112 (e.g., as submitted to or as modified by a user of the client device 108), the system generator 102 generates additional data or content for the microservice system 104 based on the structural architecture 112 as accepted. In some embodiments, the system generator 102 selects one or more features 118 for the microservice system 104 by requesting these features 118 from the generative AI model 106. For example, in some embodiments, the generative AI model 106 may be provided a prompt or other request to select the one or more features 118 based on the accepted structural architecture 112, the requirements 110, and/or potentially other data.

The one or more features 118 are general functions that may be performed to monitor, secure, or troubleshoot the microservice system 104 overall. For example, these features 118 may include tracing, logging, metrics, timeouts, replication, and the like. In some embodiments, these features 118 are selected (e.g., by the generative AI model 106) from a predefined listing of features 118. Accordingly, in some embodiments, the generative AI model 106 selects particular features 118 that should be implemented based on the requirements and/or the structural architecture 112. In some embodiments, one or more of these features may be preselected by default.

In some embodiments, the system generator 102 generates one or more database schemas 120 for the microservice system 104. For example, in some embodiments, the structural architecture 112 may include one or more databases or tables accessible to one or more services. As another example, in some embodiments, one or more databases or tables may be added to the structural architecture 112 based on the determined features 118. Accordingly, in some embodiments, the system generator 102 generates database schemas 120 for these databases or tables. This may include prompting or otherwise requesting that the generative AI model 106 generate the database schemas 120 based on the accepted structural architecture 112 and/or the selected features 118.

In some embodiments, the system generator 102 provides the database schemas 120 to the client device 108 as review content 116. In some embodiments, this includes soliciting feedback 114 from a user of the client device 108, such as an acceptance or modification of the database schemas 120. As with the structural architecture 112, feedback 114 including a modification to the database schemas 120 may be interpreted as an implicit acceptance of the database schemas 120 as modified.

The system generator 102 has now generated data describing various components and functions of the microservice system 104 at a high hierarchical level, including the structural architecture 112, features 118, and/or database schemas 120. Next, the system generator 102 generates lower-level content for the microservice system 104 based on this higher-level content. In some embodiment, the system generator 102 generates one or more interfaces 122 for the microservice system 104. As described herein, an interface 122 is data that abstracts the functions that a particular component of the microservice system 104 should implement. In some embodiments, each interface 122 may correspond to a particular service of the microservice system 104 and may include function signatures for one or more functions that should be implemented by the corresponding service. A function signature defines various attributes of a function, such as the name, the data types for its parameters, a data type to be returned by the function, and the like, omitting the actual function body of the function. In other words, a function signature defines the inputs and/or outputs of a function while omitting the code that will be executed when the corresponding function is executed.

In some embodiments, generating the one or more interfaces 122 includes prompting or requesting the generative AI model 106 to generate the one or more interfaces 122. The generative AI model 106 may generate these interfaces 122 based on the requirements 110 and/or any of the data previously generated by the generative AI model 106 including the structural architecture 112, features 118, and/or database schemas 120. In some embodiments, the generative AI model 106 generates the one or more interfaces 122 by generating an implementation plan that indicates various function calls and their dependencies. These function calls and dependencies may then be reflected in the generated interfaces 122.

In some embodiments, the system generator 102 verifies the generated interfaces 122 against the structural architecture 112. This may include, for example, verifying that each interface 122 correctly corresponds to some component in the structural architecture 112. This may also include determining whether each dependency indicated in the structural architecture 112 is reflected or represented by a function signature. For example, where a dependency indicates that a first service calls a second service, verifying the interfaces 122 may include determining that an interface 122 for the first service includes a signature for a function that calls the second service and/or that an interface 122 for the second service includes a signature for a function that may be executed by the first service. Other approaches may also be used to verify the interfaces 122.

In some embodiments, the system generator 102 provides these interfaces 122 to the client device 108 as review content 116 for user review. In some embodiments, the system generator 102 provides the interfaces 122 themselves or as data describing the interfaces 122 to the client device 108. For example, in some embodiments, the system generator 102 may provide, as review content 116, one or more Unified Modeling Language (UML) diagrams or other visual representations of the one or more interfaces 122 to the client device 108. In some embodiments, the client device 108 may provide feedback 114 as described above, including an acceptance or modification to the interfaces 122.

In some embodiments, the system generator 102 generates documentation 124 for the microservice system 104. In some embodiments, where the system generator 102 solicits feedback 114 for the interfaces 122, the system generator 102 generates documentation 124 in response to an acceptance of the interfaces 122 (e.g., either explicit or implicit via a modification to the interfaces 122). In some embodiments, the documentation 124 includes a natural language description of each function represented by each function signature in the one or more interfaces. In some embodiments, the documentation 124 includes supporting information related to the microservice system 104 as a whole, such as one or more README files. In some embodiments, this supporting information may be encoded as unstructured natural language content, using a markup language, or otherwise encoded. In some embodiments, this supporting information may include various information related to the deployment and use of the microservice system 104 such as a project description, installation instructions, usage examples, contribution guidelines, contact info, license info, or other information as can be appreciated.

In some embodiments, generating the documentation 124 includes prompting or requesting the generative AI model 106 to generate the documentation 124. In some embodiments, the generative AI model 106 may generate the documentation 124 based on the one or more interfaces 122. In some embodiments, the generative IA model 106 may generate the documentation 124 based on other data generated by the generative AI model 106 including the structural architecture 112, features 118, database schemas 120, and the like.

Having generated the interfaces 122 and documentation 124, the system generator 102 uses the interfaces 122 and/or documentation 124 to generate content at a lower hierarchical level. Particularly, the system generator 102 generates functional code 126 for the microservice system 104, including code 126 implementing the one or more interfaces 122. The code 126 implementing the one or more interfaces 122 includes code 126 for the body of functions defined by the function signatures in the interfaces 122.

In some embodiments, before generating the code 126 implementing the one or more interfaces 122, the system generator 102 generates one or more unit tests 128. As would be understood by one skilled in the art, a unit test 128 includes executable code that verifies the functionality of some component of a computing system. Here, the one or more unit tests 128 are generated to verify the functionality of each function having a signature in the one or more interfaces 122. Accordingly, in some embodiments, the system generator 102 may prompt or request the generative AI model 106 to generate the unit tests 128 based on the one or more interfaces 122. In some embodiments, the generative AI model 106 is provided, as input, or otherwise accesses an implementation plan. For example, in some embodiments, where generating the interfaces 122 includes generating an implementation plan as described above, the implementation plan is used by the generative AI model to ensure that the unit tests 128 and the functions of interfaces 122 are consistent with one another. Readers will appreciate that, as the function signatures define the particular inputs and outputs of a function, the generative AI model 106 does not need code 126 implementing the functions in order to generate the unit tests 128. This is similar to some existing software development paradigms whereby tests are created before the code to be tested.

In some embodiments, the system generator 102 validates the generated unit tests 128 by performing a syntax check. Should a unit test 128 fail a syntax check, the system generator 102 will provide, to the generative AI model 106, an indication that the unit test 128 failed that causes the generative AI model 106 to regenerate the failed unit test 128. This process may repeat until a generated unit test 128 passes the syntax check.

After generating the unit tests 128, the system generator 102 generates the code 126 implementing the one or more interfaces 122. In some embodiments, this includes prompting or requesting the generative AI model 106 to generate the code 126 implementing the one or more interfaces 122. In some embodiments, the generative AI model 106 generates the code 126 based on the one or more unit tests 128 and potentially other data, including any of the data described above as being generated by the generative AI model 106.

In some embodiments, the system generator 102 validates the generated code 126. In some embodiments, validating the code 126 includes performing a syntax check on the code 126. In some embodiments, validating the code 126 includes performing a static code analysis on the code 126. The static code analysis serves to identify various issues that may be present in the code 126, including compile-time issues and/or bugs. In some embodiments, should some code 126 fail verification, the system generator 102 provides, to the generative AI model 106, an indication that the code 126 failed that causes the generative AI model 106 to regenerate the failed code 126. In some embodiments, this process may repeat until a generated code 126 passes the verification.

Next, in some embodiments, the system generator 102 executes the one or more unit tests 128 against the generated code 126. In some embodiments, if a portion of code 126 fails a unit test 128, the system generator 102 provides, to the generative AI model 106, data describing the failed unit test 128 and/or the corresponding code 126. In some embodiments, this may cause the generative AI model 106 to regenerate the unit test 128 and/or the code 126. Readers will appreciate that, in some embodiments, a failed unit test 128 may be caused by an error in the tested code 126 and/or in the unit test 128 itself. Accordingly, the ability for generative AI models 106 to interpret code 126 is leveraged so that the generative AI model 106 determines whether the code 126 or the unit test 128 should be corrected.

Once the code 126 passes the unit tests 128 the system generator 102 may compile the code 126 into a build of the microservice system 104. This may include, for example, compiling the code 126 using a microservice compiler. In some embodiments, the microservice compiler may add infrastructure code and/or code integrating various services together for the build of the microservice system 104. Various actions may then be taken using the build of the microservice system 104. For example, in some embodiments, the build may be stored in a storage location accessible to the client device 108. As another example, in some embodiments, the build may be provided to the client device 108.

Readers will appreciate that the approaches set forth herein allow for automatically generating a microservice system 104 using a generative AI model 106. This leverages the ability for generative AI models 106 to interpret natural language so as to create a microservice system 104 reflecting user-provided requirements 110. By generating the microservice system 104 hierarchically a user may provide feedback 114 and modifications, as necessary, to ensure that the content generated for any hierarchical level is correct before proceeding with generating content for the next hierarchical level. This improves the accuracy and relevance of the content produced by the generative Ai model 106 and, by extension, the resulting microservice system 104 as a whole. This reduces the likelihood of bugs or other defects, improving performance, while reducing development time.

The approaches herein describe the generative AI model 106 generating some content based on some other data. In some embodiments, this other data may be provided as input to the generative AI model 106, such as part of a prompt or request to generate the content. In some embodiments, this other data may be otherwise accessible to the generative AI model 106 without explicitly being included in the request or prompt to the generative AI model 106. For example, in some embodiments, the generative AI model 106 may generate some content based on other content previously generated by the generative AI model 106. In this example, the previously generated other content may be accessible to or usable by the generative AI model 106 by being stored in a history, memory, cache, or attention window of the generative AI model 106. For example, a prompt to the generative AI model 106 to generate code 126 implementing previously generated interfaces 122 may omit the interfaces 122 themselves, which may cause the generative AI model 106 to access the interfaces 122 from its history or memory for use in generating the code 126. As another example, in some embodiments, one or more portions of data usable by the generative AI model 106 in generating some content may be accessed in response to a prompt or request using retrieval-augmented generation (RAG) or some other approach.

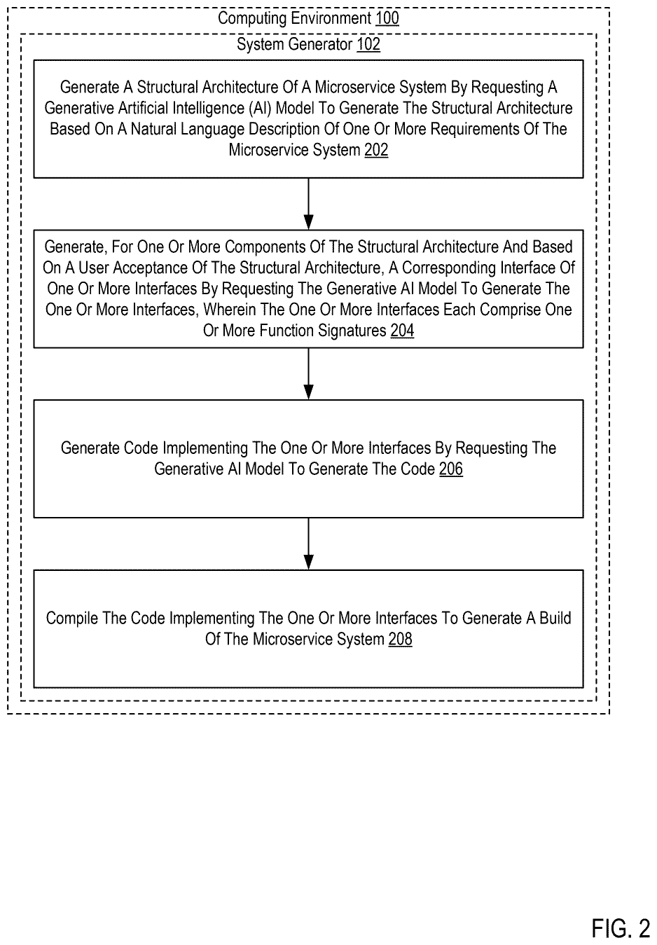

For further explanation, FIG. 2 sets forth a flowchart of another example method of automated design and generation of microservice systems in accordance with some embodiments of the present disclosure. The method of FIG. 2 may be performed, for example, by the system generator 102 of the computing environment 100 of FIG. 1. The method of FIG. 2 includes generating 202 a structural architecture 112 of a microservice system 104 by requesting a generative artificial intelligence (AI) model 106 to generate the structural architecture 112 based on a natural language description of one or more requirements 110 of the microservice system 104. The requirements 110 describe various aspects that should be present in or supported by the microservice system 104. These aspects may include, for example, a general description of the microservice system 104, one or more functional requirements 110 describing specific tasks, functions, or actions that should be performed by the microservice system 104, and/or one or more behavioral requirements 110 describing general behavior of the microservice system 104 as opposed to specific functions.

The one or more requirements 110 may be expressed using various approaches. For example, in some embodiments, the general description of the microservice system 104 and/or behavioral requirements 110 may be expressed as free-form natural language expressions. As another example, in some embodiments, the one or more functional requirements 110 may be expressed using user stories that describe, from the perspective of a particular user or type of user, an action that the particular user or type of user should be able to perform in the microservice system 104.

The structural architecture 112 describes or encodes various high-level components of the microservice system 104. For example, these components may include one or more services of the microservice system 104, one or more user interfaces or front-end components for interacting with these services, and the like. In some embodiments, the structural architecture 112 describes or encodes one or more dependencies or relationships between components. For example, in some embodiments, a front-end component such as a user interface may be related to or dependent upon one or more services accessible to that front-end component. As another example, a first service calling a second service may be related to or dependent upon that second service. Other components or relationships are also contemplated within the scope of the present disclosure. In some embodiments, the structural architecture 112 may be encoded as a graph representation with each entity of the microservice system 104 represented by a node and each dependency or relationship represented by an edge between nodes. In some embodiments, the structural architecture 112 may be encoded as an Entity Relationship (ER) diagram or other diagram as can be appreciated.

As is set forth above, generating 202 a structural architecture 112 of a microservice system 104 includes requesting a generative AI model 106 to generate the structural architecture 112 based on a natural language description of one or more requirements 110 of the microservice system 104. Accordingly, in some embodiments, the one or more requirements 110 may be included in a prompt or other request to the generative AI model 106 to generate the structural architecture 112. In some embodiments, the structural architecture 112 is received as an output from the generative AI model 106 in response to this prompt or request.

In some embodiments, after generating 202 the structural architecture 112, the structural architecture 112 is provided to a client device 108 for review (e.g., a client device 108 from which the requirements 110 are received). In some embodiments, providing the structural architecture 112 to the client device 108 causes a visual representation of the structural architecture 112 to be rendered or presented by the client device 108, such as a graph visualization depicting the various entities and dependencies encoded by the structural architecture 112. The client device 108 then provides feedback 114 for the structural architecture 112 to the system generator 102. In some embodiments, the feedback 114 includes an acceptance of the structural architecture 112. In some embodiments, the feedback 114 includes a modification to the structural architecture 112. This may include, for example, addition or removal of one or more components, addition or removal of one or more dependencies or relationships, and the like. In some embodiments, where the feedback 114 includes a modification to the structural architecture 112, this feedback 114 may be treated as an implicit acceptance of the structural architecture 112 as modified.

The method of FIG. 2 also includes generating 204, for one or more components of the structural architecture 112 and based on a user acceptance of the structural architecture 112, a corresponding interface 122 of one or more interfaces 122 by requesting the generative AI model 106 to generate the one or more interfaces 122, wherein the one or more interfaces 122 each comprise one or more function signatures. The user acceptance of the structural architecture 112 may include an explicit acceptance of the structural architecture 112 or an implicit acceptance by modifying the structural architecture 112.

An interface 122 is data that abstracts the functions that a particular component of the microservice system 104 should implement. In some embodiments, each interface 122 may correspond to a particular service of the microservice system 104 and may include function signatures for one or more functions that should be implemented by the corresponding service. A function signature defines various attributes of a function, such as the name, the data types for its parameters, a data type to be returned by the function, and the like, omitting the actual function body of the function. In other words, a function signature defines the inputs and/or outputs of a function while omitting the code that will be executed when the corresponding function is executed.

The one or more interfaces 122 are generated 204 by requesting the generative AI model 106 to generate the one or more interfaces 122. Accordingly, in some embodiments, generating 204 the one or more interfaces 122 includes providing a prompt or request to the generative AI model 106 to generate the one or more interfaces 122 based on the structural architecture 112. In some embodiments, the generative AI model 106 may generate the one or more interfaces 122 based on data in addition to the one or more interfaces 122. This data may include, for example, any data previously generated by the generative AI model 106 based on the requirements 110 and/or the requirements 110 themselves. The one or more interfaces 122 are received as output from the generative AI model 106 in response to this prompt or request.

In some embodiments, after generating 204 the one or more interfaces 122, the one or more interfaces 122 are provided to the client device 108 for user review. In some embodiments, this includes soliciting feedback 114 (e.g., an acceptance or modification) from the user of the client device 108. In some embodiments, presenting the interfaces 122 for review includes providing one or more UML diagrams or other visual representations of the interfaces 122 to the client device 108. In some embodiments, presenting the interfaces 122 for review includes providing code that encodes the interfaces 122 to the client device 108.

The method of FIG. 2 also includes generating 206 code 126 implementing the one or more interfaces 122 by requesting the generative AI model 106 to generate the code 126. The code 126 implementing the one or more interfaces 122 includes code 126 for the body of functions defined by the function signatures in the interfaces 122. In some embodiments, generating 206 the code 126 implementing the one or more interfaces 122 includes prompting or requesting that the generative AI model 106 generate the code 126 based on the one or more interfaces 122 and potentially other data. For example, as will be described in further detail below, the generative AI model 106 may be provided, as an input for generating the code 126, one or more unit tests 128 for the functions indicated in the one or more interfaces 122. In some embodiments, the generative AI model 106 may also generate the code 126 based on any of the data previously generated by the generative AI model 106, including any modifications thereto, based on the requirements 110.

Various actions may be performed using the generated 206 code 126. In some embodiments, the code 126 is verified by performing a syntax check or, as will be described in further detail below, a static analysis of the code 126. In some embodiments, verification includes executing one or more unit tests 128 for the code 126. If the code 126 fails verification the code 126 is regenerated until the code 126 passes verification.

The method of FIG. 2 also includes compiling 208 the code 126 implementing the one or more interfaces 122 to generate a build of the microservice system 104. This may include, for example, compiling the code 126 using a microservice compiler. In some embodiments, the microservice compiler may add infrastructure code and/or code integrating various services together for the build of the microservice system 104. Various actions may then be taken using the build of the microservice system 104. For example, in some embodiments, the build may be stored in a storage location accessible to the client device 108. As another example, in some embodiments, the build may be provided to the client device 108.

Readers will appreciate that in some embodiments, rather than compiling 208 the code 126 implementing the one or more interfaces 122 to generate a build of the microservice system 104, embodiments may be configured to generate a deployable build of the microservice system based on the code 126. In some embodiments, generating a deployable build of the microservice system based on the code includes producing one or more deployable artifacts that can be executed within a target runtime environment, such as a container orchestration platform (e.g., Kubernetes). The code generated for the microservice components may be compiled (e.g., Go, Java) or interpreted (e.g., Python, JavaScript), and the build process may therefore include steps beyond compilation, such as bundling dependencies, applying configuration files, generating container images, and producing service definitions or orchestration templates. In cases where the generated code is not compiled, the system may still generate an executable or launchable version by packaging the code with its required runtime and supporting files into a structured directory, archive, or container image.

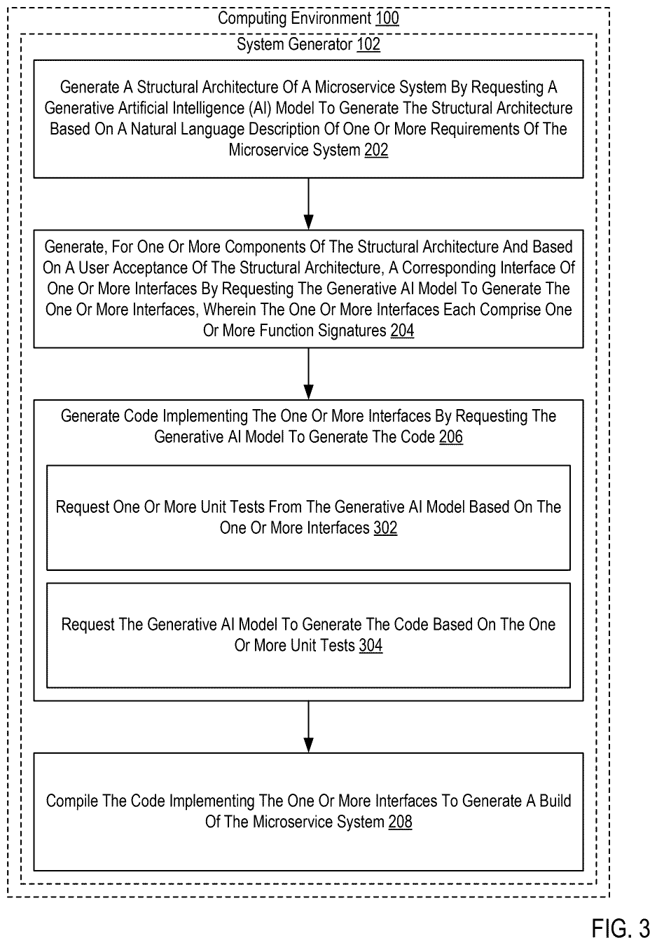

For further explanation, FIG. 3 sets forth a flowchart of another example method of automated design and generation of microservice systems in accordance with some embodiments of the present disclosure. The method of FIG. 3 is similar to FIG. 2, differing in that generating 206 code 126 implementing the one or more interfaces 122 by requesting the generative AI model 106 to generate the code 126 also includes requesting 302 one or more unit tests 128 from the generative AI model 106 based on the one or more interfaces 122. The unit tests 128 are executable code that verify the functionality of each function having a signature in the one or more interfaces 122. Accordingly, in some embodiments, the system generator 102 may prompt or request the generative AI model 106 to generate the unit tests 128 based on the one or more interfaces 122.

The method of FIG. 3 further differs from FIG. 2 in that generating 206 code 126 implementing the one or more interfaces 122 also includes requesting 304 the generative AI model 106 to generate the code 126 based on the one or more unit tests 128. This allows the generative AI model 106 to generate the code 126 with the goal of the resulting code 126 passing the previously generated unit tests 128.

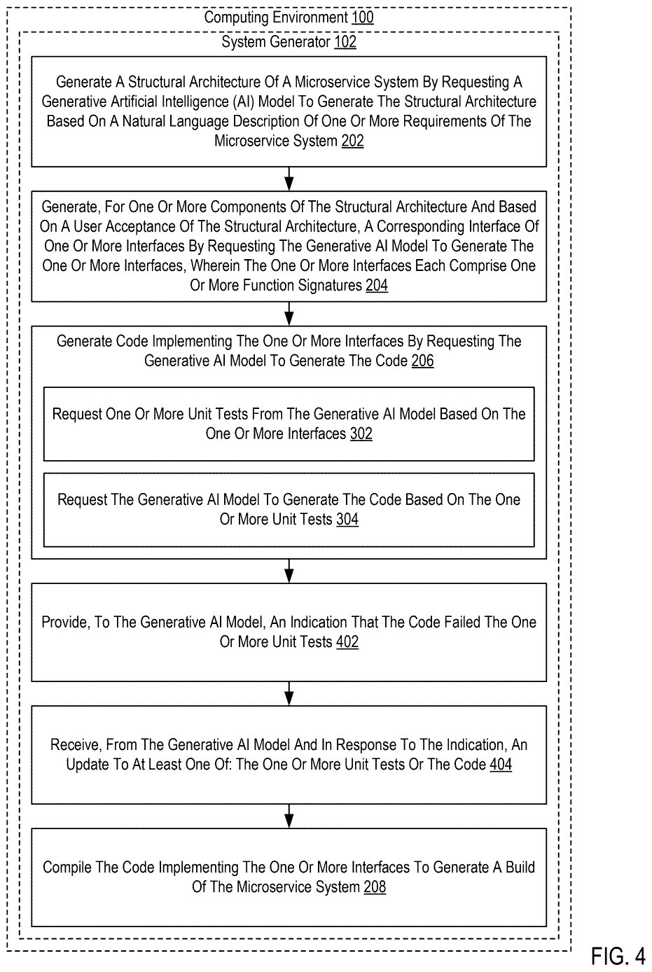

For further explanation, FIG. 4 sets forth a flowchart of another example method of automated design and generation of microservice systems in accordance with some embodiments of the present disclosure. The method of FIG. 4 is similar to FIG. 3, differing in that the method of FIG. 4 also includes providing 402, to the generative AI model 106, an indication that the code 126 failed the one or more unit tests 128. After generating 206 the code 126 implementing the one or more interfaces 122, the unit tests 128 used to generate the code 126 may be executed against the code 126 to determine if the generated code 126 passes the unit tests 128. In this example, some amount of code 126 has failed a unit test 128. The indication that the code 126 failed the one or more unit tests 128 may include, for example, an indication of the failed unit test 128 and related code 126, an output from executing the failed unit tests 128 that describes why the unit test 128 failed, and potentially other data.

The method of FIG. 4 also includes receiving 404, from the generative AI model 106 and in response to the indication, an update to at least one of: the one or more unit tests 128 or the code 126. Readers will appreciate that, in some embodiments, a failed unit test 128 may be caused by an error in the tested code 126 and/or in the unit test 128 itself. Accordingly, the ability for generative AI models 106 to interpret code 126 is leveraged so that the generative AI model 106 determines whether the code 126 or the unit test 128 should be corrected.

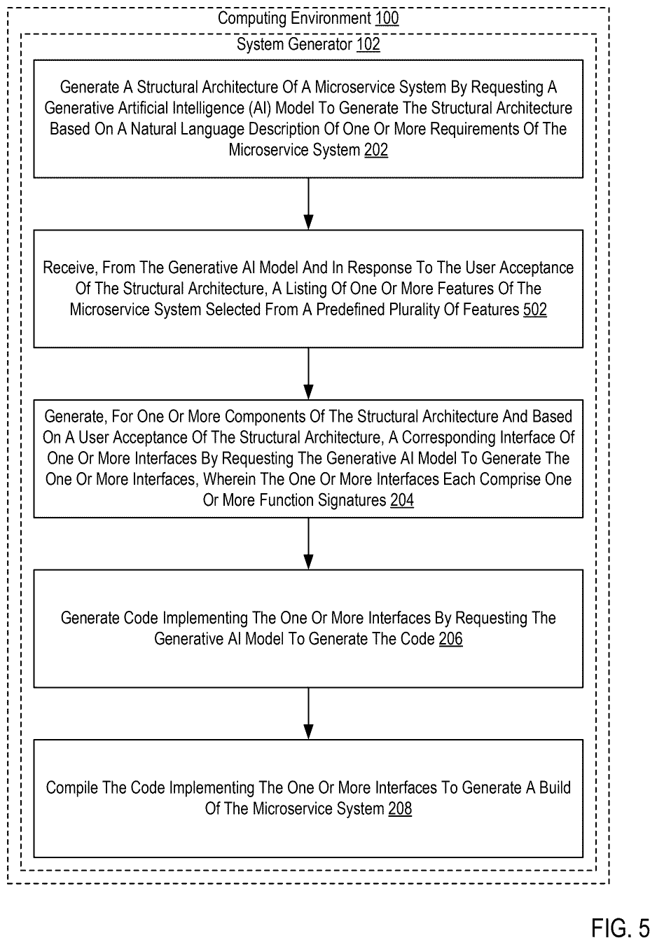

For further explanation, FIG. 5 sets forth a flowchart of another example method of automated design and generation of microservice systems in accordance with some embodiments of the present disclosure. The method of FIG. 5 is similar to FIG. 2, differing in that the method of FIG. 5 also includes receiving 502, from the generative AI model 106 and in response to the user acceptance of the structural architecture 112, a listing of one or more features 118 of the microservice system 104 selected from a predefined plurality of features 118. This may include providing a prompt or request to the generative AI model 106 to select the one or more features 118 based on the accepted structural architecture 112 and/or the requirements 110. The one or more features 118 are general functions that may be performed to monitor, secure, or troubleshoot the microservice system 104 overall. For example, these features 118 may include tracing, logging, metrics, timeouts, replication, and the like. In some embodiments, these features 118 are selected (e.g., by the generative AI model 106) from a predefined listing of features 118. Accordingly, in some embodiments, the generative AI model 106 selects particular features 118 that should be implemented based on the requirements and/or the structural architecture 112. In some embodiments, one or more of these features may be preselected by default.

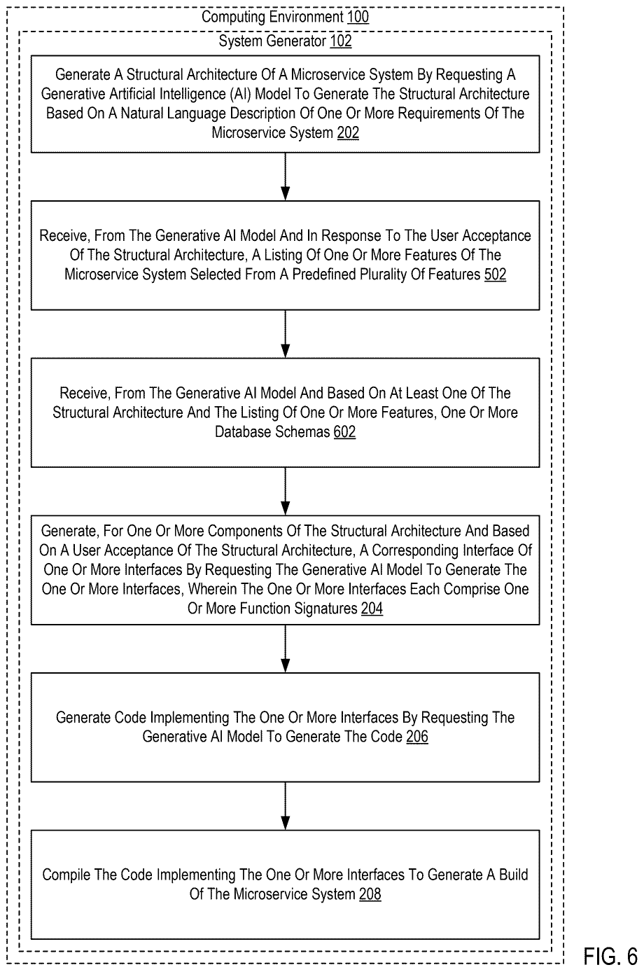

For further explanation, FIG. 6 sets forth a flowchart of another example method of automated design and generation of microservice systems in accordance with some embodiments of the present disclosure. The method of FIG. 6 is similar to FIG. 5, differing in that the method of FIG. 6 also includes receiving 602, from the generative AI model 106 and based on at least one of the structural architecture 112 and the listing of one or more features 118, one or more database schemas 120. In some embodiments, the structural architecture 112 may include one or more databases or tables accessible to one or more services. Accordingly, in some embodiments, the generative AI model 106 may generate database schemas 120 for databases included in the structural architecture 112. In some embodiments, the structural architecture 112 may not explicitly include a database. Accordingly, in some embodiments, the generative AI model 106 may determine that one or more databases should be added to the structural architecture 112 (e.g., based on a current state of the structural architecture 112, the features 118, and/or the requirements 110) and generate database schemas 120 for the databases to be added. In some embodiments, the database schemas 120 are provided to the client device 108 for review. This may include soliciting acceptance or modification to the database schemas 120. These database schemas 120 may then be used by the generative AI model 106 in generating other content at a lower hierarchical level such as the one or more interfaces 122 described above.

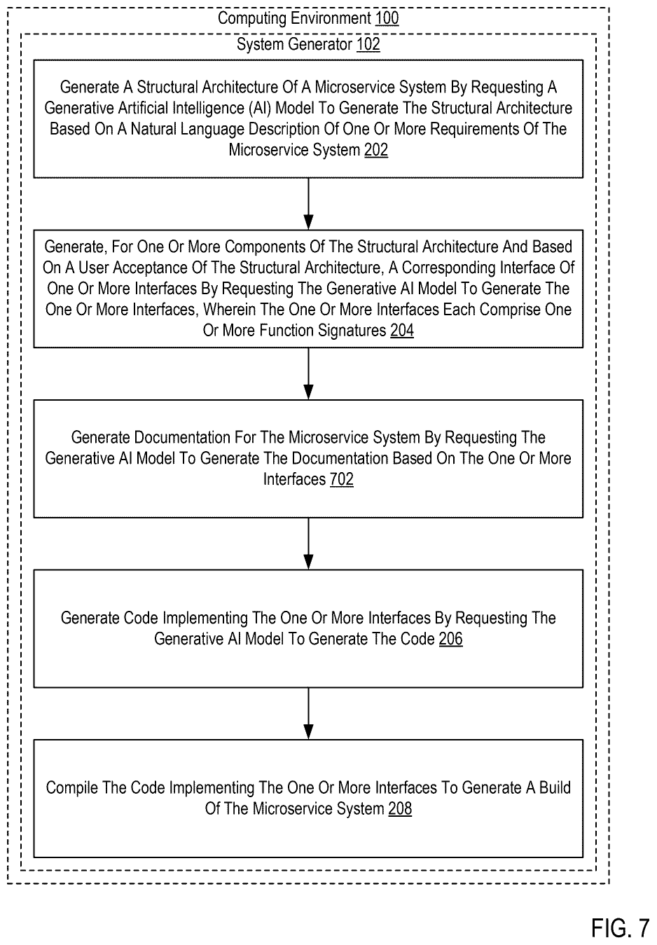

For further explanation, FIG. 7 sets forth a flowchart of another example method of automated design and generation of microservice systems in accordance with some embodiments of the present disclosure. The method of FIG. 7 is similar to FIG. 2, differing in that the method of FIG. 7 also includes generating 702 documentation 124 for the microservice system 104 by requesting the generative AI model 106 to generate the documentation 124 based on the one or more interfaces 122. In some embodiments, the documentation 124 includes a natural language description of each function represented by each function signature in the one or more interfaces. In some embodiments, the documentation 124 includes supporting information related to the microservice system 104 as a whole, such as one or more README files. In some embodiments, this supporting information may be encoded as unstructured natural language content, using a markup language, or otherwise encoded. In some embodiments, this supporting information may include various information related to the deployment and use of the microservice system 104 such as a project description, installation instructions, usage examples, contribution guidelines, contact info, license info, or other information as can be appreciated.

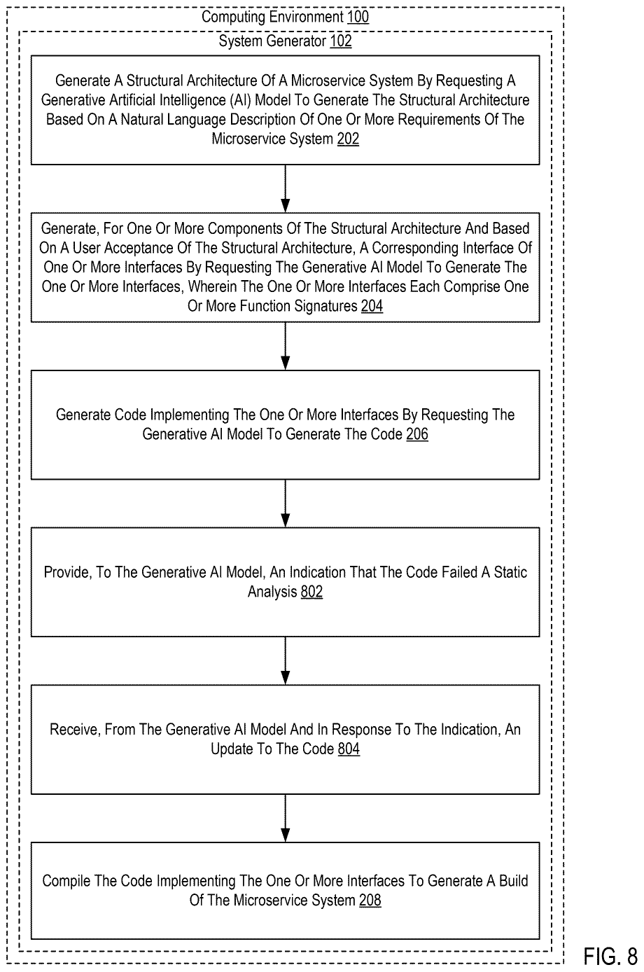

For further explanation, FIG. 8 sets forth a flowchart of another example method of automated design and generation of microservice systems in accordance with some embodiments of the present disclosure. The method of FIG. 8 is similar to FIG. 2, differing in that the method of FIG. 8 also includes providing 802, to the generative AI model 106, an indication that the code 126 failed a static analysis; and receiving 804, from the generative AI model 106 and in response to the indication, and update to the code 126. The static code analysis serves to identify various issues that may be present in the code 126, including compile-time issues and/or bugs. The static code analysis may be performed using any static code analysis technique as would be understood by one skilled in the art. In this example, some portion of code 126 failed the static code analysis. Accordingly, an indication of the failed static code analysis is provided 802 to the generative AI model 106 that causes the generative AI model 106 to regenerate the portion of code 126 that failed the static code analysis. Thus, in some embodiments, the generative AI model 106 repeatedly or iteratively regenerates code 126 until it passes verification, including a static code analysis.

In some embodiments, the system generator 102 may also generate a workload or synthetic traffic profile to simulate real-world usage of the microservice system. This workload may be used to validate the functional behavior, scalability, or performance of the generated system under load conditions. In such cases, the system generator may monitor responses to the workload and use feedback from observed behavior to further refine the generated code, improve test coverage, or adjust system parameters. This allows the system to not only verify correctness through unit and static analysis but also to evaluate runtime behavior in a representative environment. In some embodiments, these workloads may be used for end-to-end testing to validate the correctness of the system.

Additionally, while some embodiments described herein focus on generating a complete microservice system, the system generator may also be used to create or update only a portion of a system. For example, a user may provide an existing architecture and request that the system generator extend it with new services, update existing services based on changed requirements, or regenerate specific interfaces or implementations. This allows the system generator to support incremental development and modernization workflows.

Further, the code generated by the system generator may include not only the implementation of functional interfaces but also ancillary artifacts such as infrastructure logic, deployment configurations, integration scaffolding, initialization scripts, and other supporting components. These artifacts help ensure that the resulting microservice system is not only functional, but also readily deployable and maintainable within modern application environments.

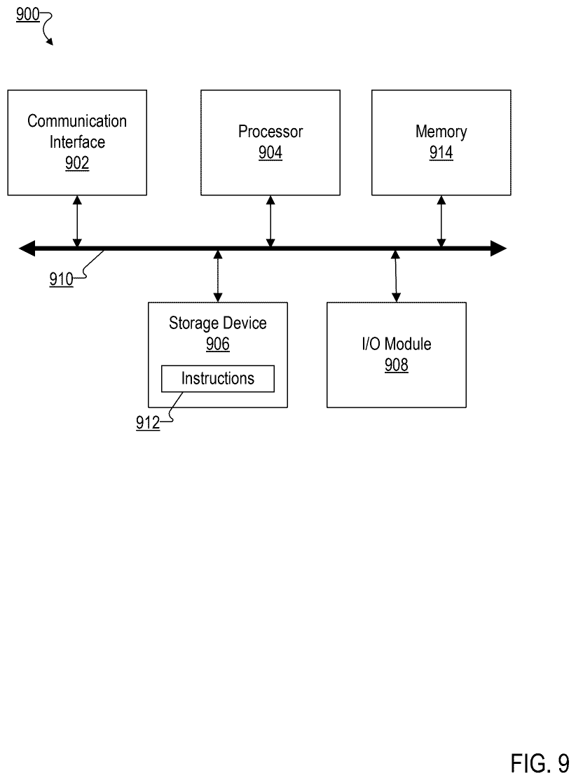

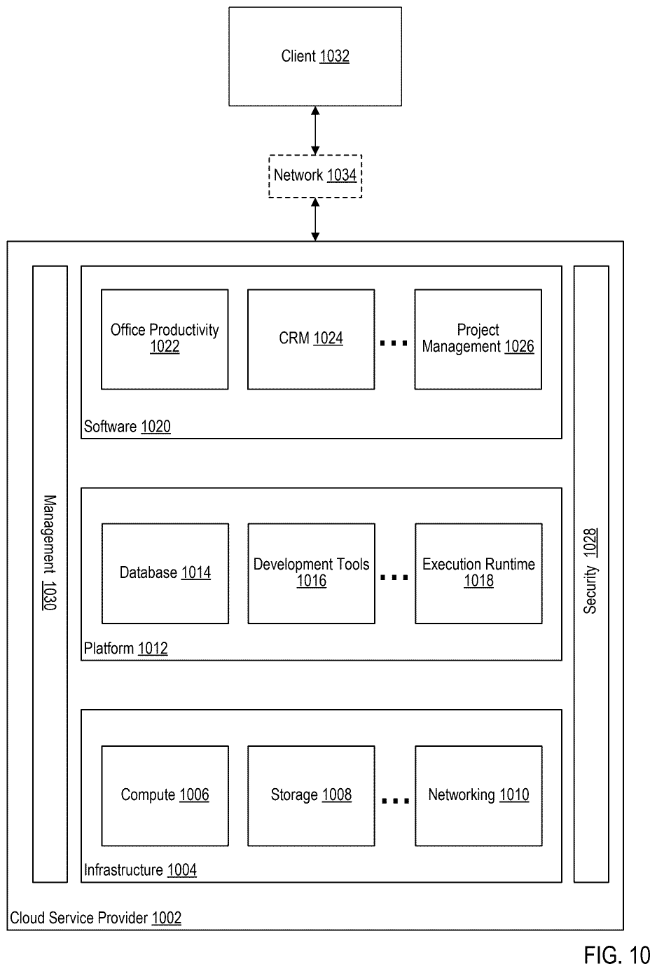

For further explanation, the sections included below provide some details regarding technologies that may be used to support automated design and generation of microservice systems in accordance with some embodiments. For example, FIG. 9 sets forth an example of a computing device that may be used for some portion of securing an operating system in accordance with some embodiments. As an additional example of technologies that may be used to support automated design and generation of microservice systems, FIG. 10 sets forth a block diagram of a cloud service provider 1002 service architecture in accordance with some embodiments of the present disclosure.

For further explanation, FIG. 9 illustrates an exemplary computing device 900 that may be specifically configured to perform one or more of the processes described herein. As shown in FIG. 9, computing device 900 may include a communication interface 902, a processor 904, a storage device 906, an input/output (I/O) module 908, and computer memory 914 communicatively connected one to another via a communication infrastructure 910. While an exemplary computing device 900 is shown in FIG. 9, the components illustrated in FIG. 9 are not intended to be limiting. Additional or alternative components may be used in other embodiments. Components of computing device 900 shown in FIG. 9 will now be described in additional detail.

Communication interface 902 may be configured to communicate with one or more computing devices. Examples of communication interface 902 include, without limitation, a wired network interface (such as a network interface card), a wireless network interface (such as a wireless network interface card), a modem, an audio/video connection, and any other suitable interface.

Processor 904 generally represents any type or form of processing unit capable of processing data and/or interpreting, executing, and/or directing execution of one or more of the instructions, processes, and/or operations described herein. Processor 904 may perform operations by executing computer-executable instructions 912 (e.g., an application, software, code, and/or other executable data instance) stored in storage device 906.

Storage device 906 may include one or more data storage media, devices, or configurations and may employ any type, form, and combination of data storage media and/or device. For example, storage device 906 may include, but is not limited to, any combination of non-volatile media and/or volatile media. Electronic data, including data described herein, may be temporarily and/or permanently stored in storage device 906. For example, data representative of computer-executable instructions 912 configured to direct processor 904 to perform any of the operations described herein may be stored within storage device 906. In some examples, data may be arranged in one or more databases residing within storage device 906.

I/O module 908 may include one or more I/O modules configured to receive user input and provide user output. I/O module 908 may include any hardware, firmware, software, or combination thereof supportive of input and output capabilities. For example, I/O module 908 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 908 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 908 is configured to provide graphical data to a display for presentation to a user. The graphical data may be representative of one or more graphical user interfaces and/or any other graphical content as may serve a particular implementation. In some examples, any of the systems, computing devices, and/or other components described herein may be implemented by computing device 900.

For further explanation and as an additional example of a supporting technology for automated design and generation of microservice systems, FIG. 10 sets forth a block diagram of a cloud service provider service architecture in accordance with some embodiments. The cloud service provider 1002 can deliver a variety of resources through a services-based consumption model where resources are consumed on-demand and as-a-service. Cloud service providers can provide services via cloud platforms such as, for example, Microsoft Azure™, Amazon Web Services (‘AWS’)™, Google Cloud Platform (‘GCP’)™, and others. In FIG. 10, the cloud service provider 1002 is accessed from a client device 1034 via a network 1032.

FIG. 10 depicts an embodiment where software 1020 is delivered as a service. Software-as-a-service (‘SaaS’) is a model where software applications are delivered over the internet as-a-service. Rather than installing and maintaining software locally, users can access software via a web browser or other network connected interface, eliminating the need for complex software and hardware management on the client-side. In FIG. 10, as examples of software 1020 that can be delivered as-a-service, the illustrated embodiment includes office productivity 1022 software, customer relationship management (‘CRM’) 1024 software, and project management 1026 software. The office productivity 1022 software can include applications designed to facilitate common business and personal tasks, including word processing applications, applications for spreadsheet creation, presentation design applications, and many others. The CRM 1024 software can include applications for managing a business organization's relationships and interactions with customers and potential customers. The project management 1026 software can include applications designed to help teams plan, organize, and manage projects efficiently by facilitating collaboration and tracking the progress of projects. Readers will appreciate that in other embodiments, other types of software may be delivered using a SaaS model.

FIG. 10 depicts an embodiment where platforms 1012 can be delivered as a service. Platform-as-a-service (‘PaaS’) is a model that provides cloud customers with platform resources that they can use to develop, run, and manage applications without the complexity of such deploying and managing such infrastructure on their own. In FIG. 10, as examples of platform 1012 resources that can be delivered as-a-service, the illustrated embodiment includes database 1014 services, development tools 1016 services, and execution runtime 1018 services. The database 1014 services can be used to provide access to databases without management overhead for the user as the cloud service provider manages the provisioning, scaling, and maintenance of the databases. The development tools 1016 services can provide developers with tools to design, develop, test, and deploy applications without needing to manage the underlying infrastructure. The execution runtime 1018 services can provide environments where applications or other forms of computer program code can be executed, including services to scale the execution environment. Readers will appreciate that in other embodiments, other platform resources may be delivered using a PaaS model.

FIG. 10 depicts an embodiment where infrastructure 1004 can be delivered as a service. Infrastructure-as-a-Service (‘IaaS’) is a model that provides virtualized computing resources over the internet, such that infrastructure such as servers, storage, networks, and others may be leased on demand rather than purchasing and maintaining physical hardware. In FIG. 10, as examples of infrastructure 1004 resources that can be delivered as-a-service, the illustrated embodiment includes compute 1006 services, storage 1008 services, and networking 1010 services. The compute 1006 services can be used to provide on-demand access to computational resources such as VMs, containers, and serverless functions, where the cloud service provider manages the provisioning, scaling, and maintenance of such resources. The storage 1008 services can provide storage resources that can be used to store and access data, without the need for customers to purchase and manage on-premises physical storage resources. The networking 1010 services can provide the ability to create and manage virtualized networking resources such as, for example, virtual private networks (‘VPNs’), firewalls, load balancers, and more. Readers will appreciate that in other embodiments, other infrastructure resources may be delivered using a PaaS model.

The cloud service provider of FIG. 10 also provides management 1030 resources. The management 1030 resources can include, for example, tools and interfaces that enable customers to efficiently deploy, monitor, and manage, their cloud services. Such tools can include web-based management consoles, command-line interfaces (‘CLIs’), APIs, automation tools, and other tools.

The cloud service provider of FIG. 10 also provides security 1028 resources. The security 1028 resources can include, for example, tools and services to help customers protect their cloud environments and ensure compliance with security standards. These tools and services may provide specific aspects of security, including identity and access management, network security, threat detection, compliance management, and others.

While certain embodiments described herein refer to LLMs as examples of generative AI models, it will be appreciated that other types of generative models may be used. For instance, the generative AI model may include multimodal models, models trained on domain-specific data, or models implementing alternative architectures such as diffusion models, encoder-decoder frameworks, or other machine learning approaches capable of generating content in response to inputs. The choice of model architecture or training data may vary based on the specific implementation, performance requirements, or target application domain.

In some embodiments, input to the generative AI model is described in terms of prompts. While prompting is one way to supply input, other forms of input may also be used. For example, structured input such as parameter sets, configuration files, or intermediate representations may be provided. In some cases, input may be derived from a user interface (e.g., form-based input, diagrams), from existing artifacts (e.g., architectural models, code repositories), or retrieved dynamically through integration with external tools and services. Input may also be provided incrementally or interactively over multiple rounds of refinement, with the system generator using stateful context or historical interaction data to guide generation.

Accordingly, references to prompting or LLMs are intended as illustrative, and not limiting. The techniques described herein may be implemented using a variety of generative models and input mechanisms, provided that the model is capable of producing content relevant to the generation of microservice system components, such as architectures, interfaces, code, or related documentation.

Readers will appreciate that many of the components described above may be delivered as services from a cloud service provider. For example, the virtual machines, containers, and pods described above may all be delivered via a cloud service provider. In other embodiments, other forms of compute resources may be used in place of the virtual machines or other compute resource. For example, AWS EC2 instances or other form of cloud compute instances may be utilized in place of the virtual machines.

Advantages and features of the present disclosure can be further described by the following statements:
1. A method for automated design and generation of microservice systems, comprising: generating a structural architecture of a microservice system by requesting a generative artificial intelligence (AI) model to generate the structural architecture based on a natural language description of one or more requirements of the microservice system; generating, for one or more components of the structural architecture and based on a user acceptance of the structural architecture, a corresponding interface of one or more interfaces by requesting the generative AI model to generate the one or more interfaces, wherein the one or more interfaces each comprise one or more function signatures; generating code implementing the one or more interfaces by requesting the generative AI model to generate the code; and compiling the code implementing the one or more interfaces to generate a build of the microservice system.
2. The method of statement 1, wherein generating the code implementing the one or more interfaces comprises: requesting one or more unit tests from the generative AI model based on the one or more interfaces; and requesting the generative AI model to generate the code based on the one or more unit tests.
3. The method of statements 1 or 2, further comprising: providing, to the generative AI model, an indication that the code failed the one or more unit tests; and receiving, from the generative AI model and in response to the indication, an update to at least one of: the one or more unit tests or the code.
4. The method of any combination of one or more of statements 1-3, further comprising: receiving, from the generative AI model and in response to the user acceptance of the structural architecture, a listing of one or more features of the microservice system selected from a predefined plurality of features; and wherein the generative AI model generates the one or more interfaces based on the listing of the one or more features.
5. The method of any combination of one or more of statements 1-4, further comprising: receiving, from the generative AI model and based on at least one of the structural architecture and the listing of one or more features, one or more database schemas; and wherein the generative AI model generates the one or more interfaces based on the one or more database schemas.
6. The method of any combination of one or more of statements 1-5, further comprising generating documentation for the microservice system by requesting the generative AI model to generate the documentation based on the one or more interfaces.
7. The method of any combination of one or more of statements 1-6, further comprising: providing, to the generative AI model, an indication that the code failed a static analysis; and receiving, from the generative AI model and in response to the indication, an update to the code.
8. The method of any combination of one or more of statements 1-7, wherein the code implementing the one or more interfaces is generated in response to a user acceptance of the one or more interfaces.
9. An apparatus for automated design and generation of microservice systems, comprising: a memory; and one or more processing devices, operatively coupled to the memory, the one or more processing devices configured to: generate a structural architecture of a microservice system by requesting a generative artificial intelligence (AI) model to generate the structural architecture based on a natural language description of one or more requirements of the microservice system; generate, for one or more components of the structural architecture and based on a user acceptance of the structural architecture, a corresponding interface of one or more interfaces by requesting the generative AI model to generate the one or more interfaces, wherein the one or more interfaces each comprise one or more function signatures; generate code implementing the one or more interfaces by requesting the generative AI model to generate the code; and compile the code implementing the one or more interfaces to generate a build of the microservice system.
10. The apparatus of statement 9, wherein, to generate the code implementing the one or more interfaces, the one or more processing devices are further configured to: request one or more unit tests from the generative AI model based on the one or more interfaces; and request the generative AI model to generate the code based on the one or more unit tests.
11. The apparatus of statements 9 or 10, wherein the one or more processing devices are further configured to: provide, to the generative AI model, an indication that the code failed the one or more unit tests; and receive, from the generative AI model and in response to the indication, an update to at least one of: the one or more unit tests or the code.
12. The apparatus of any combination of one or more of statements 9-11, wherein the one or more processing devices are further configured to: receive, from the generative AI model and in response to the user acceptance of the structural architecture, a listing of one or more features of the microservice system selected from a predefined plurality of features; and wherein the generative AI model generates the one or more interfaces based on the listing of the one or more features.
13. The apparatus of any combination of one or more of statements 9-12, wherein the one or more processing devices are further configured to: receive, from the generative AI model and based on at least one of the structural architecture and the listing of one or more features, one or more database schemas; and wherein the generative AI model generates the one or more interfaces based on the one or more database schemas.
14. The apparatus of any combination of one or more of statements 9-13, wherein the one or more processing devices are further configured to generate documentation for the microservice system by requesting the generative AI model to generate the documentation based on the one or more interfaces.
15. The apparatus of any combination of one or more of statements 9-14, wherein the one or more processing devices are further configured to: provide, to the generative AI model, an indication that the code failed a static analysis; and receive, from the generative AI model and in response to the indication, an update to the code. 16. The apparatus of any combination of one or more of statements 9-15, wherein the code implementing the one or more interfaces is generated in response to a user acceptance of the one or more interfaces.
17. A non-transitory computer readable storage medium storing instructions which, when executed, cause a processing device to: generate a structural architecture of a microservice system by requesting a generative artificial intelligence (AI) model to generate the structural architecture based on a natural language description of one or more requirements of the microservice system; generate, for one or more components of the structural architecture and based on a user acceptance of the structural architecture, a corresponding interface of one or more interfaces by requesting the generative AI model to generate the one or more interfaces, wherein the one or more interfaces each comprise one or more function signatures; generate code implementing the one or more interfaces by requesting the generative AI model to generate the code; and compile the code implementing the one or more interfaces to generate a build of the microservice system.
18. The non-transitory computer readable storage medium of statement 17, wherein, to generate the code implementing the one or more interfaces, the instructions, when executed, further cause the processing device to: request one or more unit tests from the generative AI model based on the one or more interfaces; and request the generative AI model to generate the code based on the one or more unit tests.
19. The non-transitory computer readable storage medium of statements 17 or 18, wherein the instructions, when executed, further cause the processing device to: provide, to the generative AI model, an indication that the code failed the one or more unit tests; and receive, from the generative AI model and in response to the indication, an update to at least one of: the one or more unit tests or the code.
20. The non-transitory computer readable storage medium of any combination of one or more of statements 17-19, wherein the instructions, when executed, further cause the processing device to: receive, from the generative AI model and in response to the user acceptance of the structural architecture, a listing of one or more features of the microservice system selected from a predefined plurality of features; and wherein the generative AI model generates the one or more interfaces based on the listing of the one or more features.

Although some embodiments are described largely in the context of a system, method, or in some other way, readers will recognize that embodiments of the present disclosure may also take the form of a computer program product disposed upon computer readable storage media for use with any suitable processing system. Such computer readable storage media may be any storage medium for machine-readable information, including magnetic media, optical media, solid-state media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps described herein as embodied in a computer program product. Persons skilled in the art will recognize also that, although some of the embodiments described in this specification are oriented to software installed and executing on computer hardware, nevertheless, alternative embodiments implemented as firmware or as hardware are well within the scope of the present disclosure.

Readers will appreciate that some embodiments are described in which computer program instructions are executed on computer hardware such as, for example, one or more computer processors. Readers will appreciate that in other embodiments, computer program instructions may be executed on virtualized computer hardware (e.g., one or more virtual machines), in one or more containers, in one or more cloud computing instances (e.g., one or more AWS EC2 in-stances), in one or more serverless compute instances offered such as those offered by a cloud services provider, in one or more event-driven compute services such as those offered by a cloud services provider, or in some other execution environment.

In some examples, a non-transitory computer-readable medium storing computer-readable instructions may be provided in accordance with the principles described herein. The instructions, when executed by a processor of a computing device, may direct the processor and/or computing device to perform one or more operations, including one or more of the operations described herein. Such instructions may be stored and/or transmitted using any of a variety of known computer-readable media.

A non-transitory computer-readable medium as referred to herein may include any non-transitory storage medium that participates in providing data (e.g., instructions) that may be read and/or executed by a computing device (e.g., by a processor of a computing device). For example, a non-transitory computer-readable medium may include, but is not limited to, any combination of non-volatile storage media and/or volatile storage media. Exemplary non-volatile storage media include, but are not limited to, read-only memory, flash memory, a solid-state drive, a magnetic storage device (e.g., a hard disk, a floppy disk, magnetic tape, etc.), ferroelectric random-access memory (“RAM”), and an optical disc (e.g., a compact disc, a digital video disc, a Blu-ray disc, etc.). Exemplary volatile storage media include, but are not limited to, RAM (e.g., dynamic RAM).

One or more embodiments may be described herein with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

While particular combinations of various functions and features of the one or more embodiments are expressly described herein, other combinations of these features and functions are likewise possible. The present disclosure is not limited by the particular examples disclosed herein and expressly incorporates these other combinations.

What is claimed is:

1. A method for automated design and generation of microservice systems, comprising:
generating a structural architecture of a microservice system by requesting a generative artificial intelligence (AI) model to generate the structural architecture based on a natural language description of one or more requirements of the microservice system;
generating, for one or more components of the structural architecture and based on a user acceptance of the structural architecture, a corresponding interface of one or more interfaces by requesting the generative AI model to generate the one or more interfaces, wherein the one or more interfaces each comprise one or more function signatures;
generating code implementing the one or more interfaces by requesting the generative AI model to generate the code; and
compiling the code implementing the one or more interfaces to generate a build of the microservice system.

2. The method of claim 1, wherein generating the code implementing the one or more interfaces comprises:
requesting one or more unit tests from the generative AI model based on the one or more interfaces; and
requesting the generative AI model to generate the code based on the one or more unit tests.

3. The method of claim 2, further comprising:
providing, to the generative AI model, an indication that the code failed the one or more unit tests; and
receiving, from the generative AI model and in response to the indication, an update to at least one of: the one or more unit tests or the code.

4. The method of claim 1, further comprising:
receiving, from the generative AI model and in response to the user acceptance of the structural architecture, a listing of one or more features of the microservice system selected from a predefined plurality of features; and
wherein the generative AI model generates the one or more interfaces based on the listing of the one or more features.

5. The method of claim 4, further comprising:
receiving, from the generative AI model and based on at least one of the structural architecture and the listing of one or more features, one or more database schemas; and
wherein the generative AI model generates the one or more interfaces based on the one or more database schemas.

6. The method of claim 1, further comprising generating documentation for the microservice system by requesting the generative AI model to generate the documentation based on the one or more interfaces.

7. The method of claim 1, further comprising:
providing, to the generative AI model, an indication that the code failed a static analysis; and
receiving, from the generative AI model and in response to the indication, an update to the code.

8. The method of claim 1, wherein the code implementing the one or more interfaces is generated in response to a user acceptance of the one or more interfaces.

9. An apparatus for automated design and generation of microservice systems, comprising:
a memory; and
one or more processing devices, operatively coupled to the memory, the one or more processing devices configured to:
generate a structural architecture of a microservice system by requesting a generative artificial intelligence (AI) model to generate the structural architecture based on a natural language description of one or more requirements of the microservice system;
generate, for one or more components of the structural architecture and based on a user acceptance of the structural architecture, a corresponding interface of one or more interfaces by requesting the generative AI model to generate the one or more interfaces, wherein the one or more interfaces each comprise one or more function signatures;
generate code implementing the one or more interfaces by requesting the generative AI model to generate the code; and
compile the code implementing the one or more interfaces to generate a build of the microservice system.

10. The apparatus of claim 9, wherein, to generate the code implementing the one or more interfaces, the one or more processing devices are further configured to:
request one or more unit tests from the generative AI model based on the one or more interfaces; and
request the generative AI model to generate the code based on the one or more unit tests.

11. The apparatus of claim 10, wherein the one or more processing devices are further configured to:
provide, to the generative AI model, an indication that the code failed the one or more unit tests; and
receive, from the generative AI model and in response to the indication, an update to at least one of: the one or more unit tests or the code.

12. The apparatus of claim 9, wherein the one or more processing devices are further configured to:
receive, from the generative AI model and in response to the user acceptance of the structural architecture, a listing of one or more features of the microservice system selected from a predefined plurality of features; and
wherein the generative AI model generates the one or more interfaces based on the listing of the one or more features.

13. The apparatus of claim 12, wherein the one or more processing devices are further configured to:
receive, from the generative AI model and based on at least one of the structural architecture and the listing of one or more features, one or more database schemas; and
wherein the generative AI model generates the one or more interfaces based on the one or more database schemas.

14. The apparatus of claim 9, wherein the one or more processing devices are further configured to generate documentation for the microservice system by requesting the generative AI model to generate the documentation based on the one or more interfaces.

15. The apparatus of claim 9, wherein the one or more processing devices are further configured to:
provide, to the generative AI model, an indication that the code failed a static analysis; and
receive, from the generative AI model and in response to the indication, an update to the code.

16. The apparatus of claim 9, wherein the code implementing the one or more interfaces is generated in response to a user acceptance of the one or more interfaces.

17. A non-transitory computer readable storage medium storing instructions which, when executed, cause a processing device to:
generate a structural architecture of a microservice system by requesting a generative artificial intelligence (AI) model to generate the structural architecture based on a natural language description of one or more requirements of the microservice system;
generate, for one or more components of the structural architecture and based on a user acceptance of the structural architecture, a corresponding interface of one or more interfaces by requesting the generative AI model to generate the one or more interfaces, wherein the one or more interfaces each comprise one or more function signatures;
generate code implementing the one or more interfaces by requesting the generative AI model to generate the code; and
generate a deployable build of the microservice system based on the code.

18. The non-transitory computer readable storage medium of claim 17, wherein, to generate the code implementing the one or more interfaces, the instructions, when executed, further cause the processing device to:
request one or more unit tests from the generative AI model based on the one or more interfaces; and
request the generative AI model to generate the code based on the one or more unit tests.

19. The non-transitory computer readable storage medium of claim 18, wherein the instructions, when executed, further cause the processing device to:
provide, to the generative AI model, an indication that the code failed the one or more unit tests; and
receive, from the generative AI model and in response to the indication, an update to at least one of: the one or more unit tests or the code.

20. The non-transitory computer readable storage medium of claim 17, wherein the instructions, when executed, further cause the processing device to:
receive, from the generative AI model and in response to the user acceptance of the structural architecture, a listing of one or more features of the microservice system selected from a predefined plurality of features; and
wherein the generative AI model generates the one or more interfaces based on the listing of the one or more features.
